(19) United States
(12) Patent Application Publication
(10) Pub. No.: US 2023/0417926 A1
(43) Pub. Date: Dec. 28, 2023

(54) System and Method for Mitigating the Jamming or Spoofing of Geolocation Information

(71) Applicant: Peter Henry Mueller, West Vancouver (CA)

(72) Inventor: Peter Henry Mueller, West Vancouver (CA)

(21) Appl. No.: 18/038,191

(22) PCT Filed: Nov. 30, 2020
(86) PCT No.: PCT/IB2020/000993

§ 371 Date: May 22, 2023

(51) Int. Cl. G01S 19/21; G01S 19/11; G01S 19/08

(52) U.S. Cl. CPC G01S 19/215; G01S 19/08; G01S 19/115

(57) ABSTRACT

A system and method are described for mitigating the jamming or spoofing of information that is used in a Global Navigation Satellite System (GNSS) geolocation system, such as the Global Positioning System (GPS). In an area of interest where accurate geolocation information is critical—for example, at an airport, harbour, or other locations where accurate navigation is critical—several receiving stations having known and pre-determined geolocations are positioned. These receiving stations receive location signals from a constellation of geolocation satellites, and send the information about received signals to a central processing hub. The processing hub includes facilities to compare location information received by a particular receiving station and to determine whether the location information received by that receiving station from a particular satellite is consistent with known location information about that receiving station. In the event that there is a discrepancy—as measured by filters designed to identify signals outside set thresholds—between the known location information and the received location information, the processing hub can send a warning signal that the location information from a satellite whose location information is found outside of thresholds should be ignored and that other positioning information should be used. The system and method may also be adapted to allow overriding of incorrect or undetectable location information with correct information so that an end user may use that information to correctly navigate within an area where jamming or spoofing may be occurring.

### BACKGROUND OF THE INVENTION

### Field of the Invention

The present disclosure relates to the field of Global Navigation Satellite Systems (GNSS) such as Global Positioning System (GPS), and techniques to ensure accuracy of signals using that system, to address efforts to disrupt those signals using misleading (“spoofed”) or altered (“jammed”) signals.

### Description of Related Art

GNSS is a general nomenclature for several different systems used in geolocation, which were initially developed for military use, but have now found their way in many civilian applications. GNSS relies on signals transmitted from orbiting satellites which a receiver receives, and uses to trilaterate (or otherwise mathematically determine) the specific location of a user of the GNSS, based on information extracted from the satellite signals.

The ubiquity of the use of GNSS systems in mobile phones, watches, car, aircraft, and maritime navigation systems and many other devices where relatively precise location information is needed has led to the efforts to create false signals which attempt to inaccurately replicate (or “spoof”) true signals from a GNSS to give a receiving device incorrect location information, or alternatively to jam or otherwise impede—whether intentionally or not—true GNSS signals in order to prevent a receiving device from accurately determining its location.

Spoofing has been used as a technique to facilitate piracy or other illegal activities around commercial maritime vessels, by driving those vessels off course using spoofed GNSS signals. The result is that the vessel's GNSS system makes use of incorrect location information, causing it to steer into an area away from its desired navigational course, allowing it to founder or to be steered to a location where piracy activities are easier to commit without interdiction. This problem has become particularly prevalent in the East China, Black and Baltic seas, as well as the Strait of Hormuz.

A jammer is a simple device that injects (“blasts”) noise onto a particular radio frequency, which frequency is used by, or adjacent to, those frequencies used by a GNSS system. As a result, the user attempting to monitor its own location using GNSS signals is prevented from extracting the individual satellite signals and their resulting data used for location calculations. The user thus may have to rely upon other, less accurate, navigational techniques and as a result may steer into areas that are dangerous or which may subject them to illegal actions.

A relatively inexpensive set of equipment, a “spoofer,” can be programmed to send out radio signals that are nearly identical to the GNSS signals upon which the on-board navigation system relies; the spoofed signals deviate from the actual GNSS signals just enough to misdirect the vessel to an undesired course, without the navigation system understanding that false signals are resulting in false navigational calculations. Because GNSS signals from GNSS satellites are of relatively low power, a spoofer (or a jammer) does not need to be of relatively high-power output to disrupt a GNSS-based navigational system.

Spoofing can be more insidious than jamming in GNSS navigational systems because in the case of jamming, the user knows the signal is bad or cannot be received, and therefore the navigational system will simply be incapable of making location calculations—thereby allowing the user to turn to less accurate backup systems for navigation. In the case of spoofing, the user can be misled and misdirected along an incorrect course because the location and navigation system operates as if the spoofed signal is a correct signal and may not have the capacity to alert a pilot or navigator that the vessel is being misdirected.

GNSS systems make it possible for users of that system to extract and calculate Position, Navigation and Timing (PNT) information. This information can be used both for surveying, as well as for navigating maritime vessels and aircraft, as well as cars, trucks and buses. GNSS systems also have become useful in synchronizing networks, including financial services, stock exchanges, and wireless (cellular) telecommunication systems. All these users can be adversely affected by spoofing or jamming of the GNSS signals.

The problem is most prevalent with certain implementations of a GNSS system—such as the GPS system used in the United States—in that L1C/A (Legacy Band L1, Coarse Acquisition) is the most widely used signal. However, as there are multiple GNSS systems in place worldwide, different constellations use different signals, and satellite constellation may use multiple signals in multiple bands.

The L1 legacy signal band is centred on the 1575.42 MHz radio frequency. The public (or open) GPS signal in the L1 band uses the C/A code, which has been substantially unchanged since 1980. The coarse acquisition (C/A) code is the signal made available to the public, in contrast to the precision (P) code which is only available to military users. Both L1C/A and the military precision P code use BPSK modulation. The newest GPS III satellites add a more modern signal called L1c, also centred on 1575.42 MHz. as is L1C/A. The “c” in L1c designates that it is a “civilian” signal. It uses time-multiplexed binary offset carrier (TMBOC) modulation. TM BOC has advantages over BPSK such as better multipath and other interference mitigation.

As these signals are Code-Division, Multiple Access (CDMA), and power is carefully managed with CDMA technology, they can co-exist in the same band; a receiver of a satellite signal uses the Pseudo Random Noise (PRN) code to decode the signal from a particular satellite. Having all satellites broadcasting on a single frequency has advantages for receiver design, but also makes it easier to implement a jammer as just that one frequency needs to be blocked.

The issue of spoofing or jamming is not limited to the NAVSTAR GPS system which is used in North America; it can happen with other GNSS constellations and signals, such as China's BeiDou, Russia's GLONASS, and Europe's Galileo. Other regional systems like Japan's QZSS and India's NavIC (aka IRNSS) are theoretically vulnerable as well. Although encrypted and/or authenticated signals such as the GPS military signal M1 in North America and the Galileo OSNMA signal in Europe are much less vulnerable to spoofing, but these signals are not generally available to civilian users, who are the vast bulk of current users of GNSS navigation and location services.

Interference with GNSS signals can occur because GNSS signals, which are inherently low-powered, become overpowered by other signals on the same or adjacent frequencies. This can happen when a GNSS receiver is near other electronic devices designed to overwhelm GNSS signals (such as drones or stationary transmitters), or other devices that unintentionally interfere with GNSS signals, such as radio transmitting antennas or modems. Such interference can reduce positioning accuracy by “disabling” signals from satellites needed for trilateration, or causing the receiver to lose positional information altogether.

Spoofing is the intentional sending of incorrect or misleading GNSS signals to a receiver, so that the receiver reports incorrect location information. Such spoofing devices can be used to hijack autonomous vehicles by misdirecting their route programming, or to misdirect aircraft or maritime vessels to send them on alternate routes. As an example, in 2017, several ships in the Black Sea had their GPS receiver reporting a position at a faraway airport as the result of a spoofing attack.

There have been various efforts made in the past to provide alternate and complementary methods of detection and mitigation of GNSS spoofing and jamming, such as:
Building an advanced interference monitoring and mitigation (AIM) system into the receiver. AIM is designed to detect and neutralize interference with geolocation signals, protecting against simple narrow-band interference as well as more complex wide-band interference, including both jamming and spoofing. Some AIM systems analyze interference using spectral analysis, allowing determination of the type and possible source of the interference. An AIM system is designed to try to detect signals that may be false, or to filter out signals intended to jam true signals. AIM systems generally must be built into new receivers, although in some cases older receivers may be retrofitted to include an AIM system through firmware or other software-based updates to that receiver. A downside to AIM systems is that they require significant signal processing resources within the user's navigational system receiver to implement them effectively, and these signal processing resources are often more than many consumer devices or civilian navigational systems can accommodate. Because GNSS has become an integral part of many hundreds of millions of consumer devices, allowing low-navigation or positional information, AIM systems are not a technically feasible solution for spoofing or jamming for the receivers in those devices.
Building more resilient signals with greater signal integrity within GNSS satellites, so that at least false, spoofed, signals may be detected and ignored by the position calculation algorithms in the receiver. The Galileo OSNMA (Open Service Navigation Message Authentication) system used in European Union geolocation services is one such a system for providing greater signal integrity from the signal source satellites.

However, building signal integrity within the satellite signal can require many years to design, build and launch new satellites with improved signal integrity, and may require that the receivers all include specialized improvements and signal processing features in order to process the enhanced satellite signals. By way of example, the newest iteration of GPS, “GPS III,” only has three currently launched satellites with enhanced signal capacity, but a minimum of 24 satellites are needed to be launched into space in order for that system to provide effective coverage and for all users to be able to access enhanced GPS III signals with anti-spoofing and anti-jamming signal integrity.
Jamming detection from space has been demonstrated using a GNSS receiver on-board the International Space Station (ISS). However, a full low-earth orbit (LEO) constellation of potentially hundreds of satellites would be required for real-time global coverage of jamming detection, such as by implementing jamming detection in the Iridium constellation, which has 66 active and 9 spare satellites in space. A space-based solution is thus potentially cost-prohibitive and would take many years to implement by launching new satellites with sensitive GNSS receivers.
Combining inertial measurement units (IMUS) with GNSS receivers, so as to allow the receiving device to detect differences between movement reported by the IMU and movement calculated by the GNSS receiver, such that significant discrepancies can be flagged to alter to possible spoofing. The incorporation of an IMU into a receiver results in significant increases in power, cost and complexity in the receiving unit, and is dependent on the accuracy of the IMU and measurable discrepancies between the IMU measured distances and distances detected by the spoofed GNSS signals.
Controlled reception pattern antennas (CRPA) are in use in military environments relying upon GNSS systems. This system uses large antennas designed to be able to detect direction information about incoming signals, and to rely only on those signals for which direction is known to be satellite-based. These antennas can be bulky, complex and expensive, and some of the technology is restricted to only military use.

At present, instances of GNSS spoofing and jamming are published in, among other locations, the Notice to Airmen (NOTAM) and US Coast Guard Navigation Center (NAVCEN) Notice

Advisory to Naystar Users (NANUs) and GPS reports. Due to the dynamic nature of entities or persons attempting to spoof or jam signals, and the ability of those entities or persons to vary the location, signal features, or areas covered by their efforts to disrupt true location signals, these alerts are often out-of-date and don't provide an effective way to mitigate the effects of spoofing or jamming.

### BRIEF SUMMARY OF THE INVENTION

The present invention includes both a system, a method, and a receiver for determining if GNSS location information received by a navigating vessel are compromised. The system ensures accurate location information in a device designed to receive satellite location signals, which system includes a plurality of earth-based receivers having previously-determined known locations, wherein the plurality of earth-based receivers are designed to receive location calculation signals from a constellation of satellites. A processing hub in signal connection with the plurality of earth-based receivers receives relayed location calculation signals from the plurality of earth-based receivers and the relayed location calculation signals are compared against known good signal data to identify signals that may not be correct.

The method of the present invention ensures accurate location information in a device designed to receive satellite location signals, by providing a plurality of earth-based receivers, receiving location calculation signals at the plurality of earth-based receivers from a constellation of satellites, providing a processing hub in signal connection with the plurality of earth-based receivers, relaying location calculation signals from the plurality of earth-based receivers to the processing hub, and comparing the location calculation signals against known good signal data to identify signals that may not be accurate.

The receiving unit of the present invention is in a vessel, to ensuring accurate navigation when using satellite location signals, and comprises an antenna for receiving location calculation signals from a constellation of satellites, a receiving unit for calculating location based on the signals from the constellation of satellites, the receiving unit including an alert system to receive and transmit an alert signal to a vessel operator which the integrity of the signals received by the antenna are determined to be inaccurate.

### BRIEF DESCRIPTION OF THE SEVERAL VIEWS OF THE DRAWING

FIG. 1 is an overall view of the method and system of the present invention.

FIG. 2 is a view of the present invention showing how spoofing or jamming signals are detected as being used to interrupt or disable location signals for a user of a geolocation system.

FIG. 3 is a view of the present invention showing how signals are generated and sent to a user of a geolocation system so as to overcome any efforts to spoof signals or jam incoming geolocation signals.

FIG. 4 is a view of the present invention, showing one example of how an area affected by spoofing or jamming may be determined.

FIG. 5 is a is a view of the present invention, showing another example of how areas affected by spoofing or jamming may be determined.

FIG. 6 is a flow chart outlining one embodiment of the method of the present invention.

FIG. 7 is a flow chart outlining another embodiment of the method of the present invention.

FIG. 8 is a flow chart outlining another embodiment of the method of the present invention.

FIG. 9 is a representation of one embodiment of a user receiver which may be used with the system and method of the present invention.

FIG. 10 is a representation of the manner in which database information may be used by the processing hub of the present invention.

### DETAILED DESCRIPTION OF THE INVENTION

The system and method of the present invention is designed to ensure enhanced levels of signal integrity for a GNSS or other geolocation service receiver, without increasing the complexity, costs, power demands or other requirements at either the signal transmitters or the signal receiver.

In the present invention, areas of interest—i.e., those areas where there is likely to be spoofing or jamming directed to that area, such as airports, harbours, shipping lanes, or other areas with significant volume of valuable transportation traffic—have installed around them a series of GNSS receivers, which receivers may have multiple receiving antennas which may be used to do directional analysis of incoming signals.

Incoming legitimate GNSS signals from satellites cover a very wide area of earth because they are line-of-sight to receivers and are sent out from a position many thousands of kilometres from those receivers. In contrast, incoming signals from a spoofer or jammer cover a significantly smaller area because they are terrestrially-based, and line-of-sight to terrestrially-based receiving antennas can cover only a much small area—in most cases, only hundreds of square meters up to, in best cases (with good terrestrial line-of-sight), only a few square kilometres.

Although the present invention is focused on an implementation that includes ground-based stations in order to implement an anti-spoofing and anti-jamming method and system, the invention could be supplemented using airborne (using aircraft or stationary balloons or dirigibles) stations.

The present invention makes use of the two main components to any GNSS signal—the ephemeris and the clock. The ephemeris of a GNSS signal describes the satellites' orbital location, whereas the clock of the GNSS signal provides a reference point for the time-difference calculation used in GNSS signal location calculations using the equation: D=t*c (distance=time*speed-of-light).

By knowing a particular satellite's position at time t (based on clock and ephemeris information from that satellite's GNSS signal), together with the distance information for four or more GNSS-signaling satellites, the location on earth of any particular receiver to be calculated using trilateration.

A spoofer may make subtle changes to the ephemeris and/or clock from an incoming satellite signal and then redirect that changed signal to cause a target to go off course, or it may broadcast recorded signals from another time and another place in order to deny service or to bypass time-limits on systems, or to (for instance) keep drones away from a location by simulating a no-fly zone.

In all GNSS systems except GLONASS (which uses frequency division multiple access (FDMA)) all systems broadcast their signal in Code Division Multiple Access (CDMA), usually around a 1575.32 MHz central frequency. Each satellite in the system has a unique Pseudo Random Noise Code (PRN), which PRN acts as a code allowing the user device to extract its signal. A spoofer can multiplex signals from multiple, faked, PRNs onto the radio signal it emits as a technique for simulating authenticity of the spoofed signal.

Essentially, this single-frequency multiple-access design simplifies the design of the radio components and shifts complexity to the computational efforts, with the downside that it also simplifies the design of a spoofer or jammer, as computing costs and power (and availability of skilled programmers) are favourable.

For an area of interest, such as an airport or harbour where there is a concern that a spoofer or jammer will be used to disrupt accurate navigation for vessels approaching that area, there are placed a series of high-accuracy GNSS receivers around it. The receivers collect the GNSS signals of interest in real time, and relay them to a central point, the processing hub. The processing hub also receives real-time satellite signals from many locations around the world The availability of multiple signals from widely dispersed locations provides a high-confidence that ‘truth’—the actual signals as broadcast from the satellites—has been captured by the processing hub.

The processing hub compares the signal(s) received from each receiver, and compares that signal with known location information for that receiver, as well as location information from other receivers, and identifies and corrects for signals received which are determined to be inaccurate, based on the known coordinates of the location of the receivers, or known time information received from satellites determined not to be spoofed or jammed.

If one or more incoming signals deviates from the expected location information by more than a configurable threshold (which threshold may be set to account for variations in signals based on weather deviations or other known signal varying events), then an alert is triggered. The alert contains information about the affected region, the time the event began, the duration of the event and whether the event is ongoing, as well an identification of the particular signals which are affected. The processing hub may be designed and programmed to identify a region which is subject to jamming or spoofing, by making calculations triangulated from information from the multiple receivers, and may identify latitude, longitude and radius information for the spoofed signal or jamming signal, thereby identifying and discarding other signals that may be transmitted through, and therefore effected by, the false or jammed signal. As a result, the invention of the present invention can also allow individuals to narrow down the location of the spoofed or jamming signal, and direct them to that location to take mitigation steps to remove that signal from the area of interest, or to steer the user away from that area to an area where spoofing or jamming is calculated to not be occurring. The alert and related data are all recorded for later analysis, to thereby help in doing forensic analysis of the manner and techniques used in spoofing or jamming, thereby improving the ability to identify and mitigate future efforts to spoof or jam.

A false alert from the processing hub can be as disruptive to effective location services and navigation as a true spoofing event. To avoid false alerts, the present invention may include thresholds set in the processing hub, so as to account for minor variations in true location signals and therefore not trigger an alert in that circumstance. An alert has additional seriousness if it is ongoing, and/or if multiple GNSS stations detect the spoofing event, as the distance between stations implies that the spoofer has a high power level and is impacting many end users.

Thresholds are considered as follows. The natural variation in ionospheric and tropospheric delays as well as perturbations in the satellite orbits (and the description thereof in the broadcast ephemeris) will cause variations in the reported position of the receiver, as will wind load on the antenna mast. As a result, a threshold needs to be set for the detected variation of the receiver position, so that a ‘natural’ variation in receiver position doesn't cause an alarm. This threshold will be configurable, but a default value of 20 cm would be a typical setting for positional variance for any particular receiver. Setting the threshold to be too high, for example 10 m, may result in real spoofing or jamming event alarms being missed or delayed. For any particular set of receivers, or individual receivers within a set, different threshold values may be used to account for local conditions that might cause variance in positional signals, but which are not set too high so as to not properly detect real spoofing or jamming.

In the present invention, alerts and relevant data about the alert may be saved in a database. Statistical data can be generated related to the frequency, intensity, and sophistication of spoofing events and this data can be made available to interested parties, e.g. aviation and radio communication authorities, as a mechanism to identify trends and areas most susceptible to these activities, as a way of developing newer interdiction and mitigation steps. The present invention also allows for the location of a spoofer or jammer to deduced by trilateration if multiple receivers pick up the same spoofed signal, much in the way a GNSS system may locate a user by trilateration.

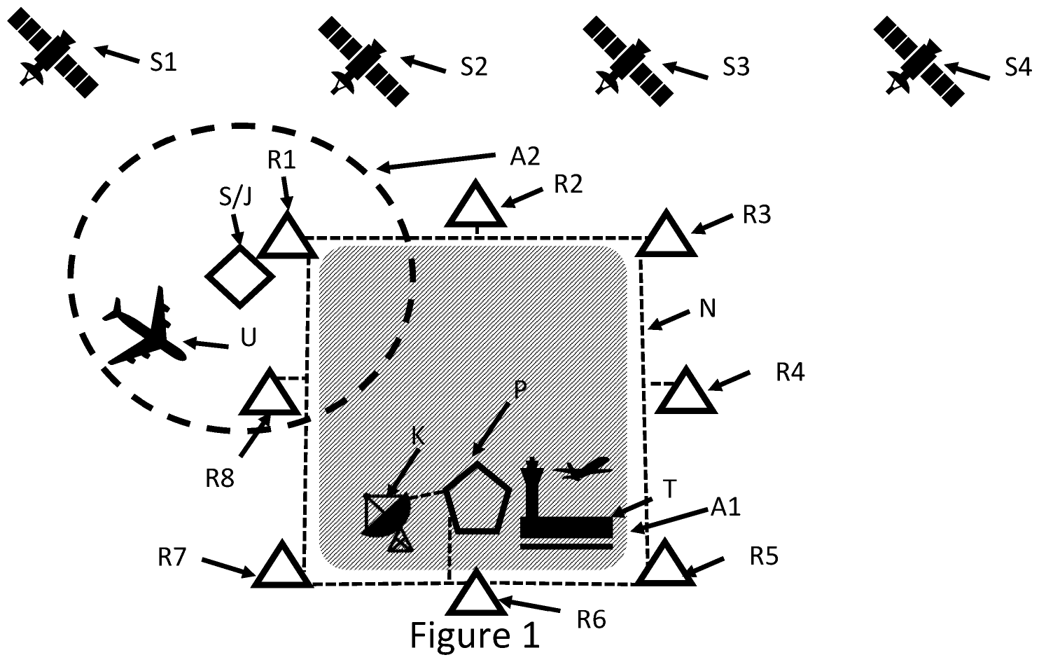

FIG. 1 shows one implementation of the system and method of the present invention. In the implementation of FIG. 1, an area for which there is a high likelihood of efforts to spoof or jam geolocation signals is shown as the region around target T, which in the example of FIG. 1 is an airport. As part of a GNSS geolocation system, multiple GNSS satellites S1, S2, S3, S4 are located in orbit around the earth, and generate GNSS signals including both ephemeris and clock data. The target T has an area A1 surrounding it, for which it is desired to prevent spoofing or jamming signals from a spoofer or jammer S/J from interfering with location information received by a user U, which in the implementation of FIG. 1 is an aircraft attempting to land at the target T airport. The spoofer of jammer S/J has been placed by a person or entity wishing to disrupt accurate location by the user U using a signal which covers a spoofing or jamming area A2, which that person or entity would place in a location so that all or part of the spoofing or jamming area A2 overlaps with the area A1, where it is important to have accurate location information so as to facilitate accurate and safe landing, in the case of an aircraft, or docking, in the case of marine vessels, or navigation, in the case of autonomous vehicles.

In the implementation of the present invention of FIG. 1, there are four GNSS receiving stations R1, R2, R3, R4, R5, R6, R7, R8 located around the area A1 where accurate and complete location information for a user U is desired. In nautical applications, such as location information for marine vessels approaching a harbour, the receiving stations R1, R2, R3, R4, R5, R6, R7, R8 would be located on shore or possibly on secure stationary buoys; in aviation applications, there would be more flexibility in locating the stations R1, R2, R3, R4, R5, R6, R7, R8 at various secure locations around the airfield. A spoofer or jammer S/J has been placed by a person or entity wishing to disrupt navigation and location information from the geolocation system within the area A1, with a signal radiating in a circle of hundreds of meters in radius, as represented by the area A2.

The GNSS receiving stations R1, R2, R3, R4, R5, R6, R7, R8 are stationary and have been carefully surveyed with regard to latitude, longitude and elevation, so as to provide more than adequate coverage for the area A1 where location accuracy is required. The purpose of conducting the careful survey of the receiving stations R1, R2, R3, R4, R5, R6, R7, R8 is to allow a processing hub P to detect anomalies in the self-calculated position of these stations using incoming signals, either true signals from satellites S1, S2, S3, S4 or false signals from spoofer or jammer S/J; such anomalies imply spoofing or jamming.

Each of the receiving stations R1, R2, R3, R4, R5, R6, R7, R8 are in signal communication via secure network N with processing hub P, which may be located at a central location near, or within, area A1, and processing hub P may also serve multiple areas for which location accuracy is needed, providing signal processing services for other banks of receiving stations covering other areas. In the embodiment of FIGS. 1-3, signal communication is achieved using a secure, hard-wired network N to prevent interference with the signals sent to processing hub P; in an alternative embodiment, the network N can be created using a wireless encrypted or otherwise secure technology to ensure signal integrity to processing hub P.

The processing hub P receives signals from the receiving stations R1, R2, R3, R4, R5, R6, R7, R8 with enough redundancy to be able to detect the true signals as broadcast from the satellites S1, S2, S3, S4. The first order of detection is to recognize that there is an inconsistency. That is, stations R1 and R2 are receiving a signal that is different from that received at stations R3, R4 etc. At this level the system and method of the present invention can warn that there is some anomalous information occurring in the region of R1, R2, R3 and R4. The next order of detection is to be able to confidently ascertain whether the correct signal is at R1 and R2, or R3 and R4. One approach that may be used in the present invention is majority voting. In order to allow for a majority voting system to work effectively, there needs to be a sufficient number of stations in a sufficiently diverse area to be able to confidently say, for example, that 3 of 10 stations are receiving signal X, but 7 of 10 stations are receiving signal Y, and therefore signal Y must be the correct satellite signal, and signal X must be from a device or devices attempting to compromise GNSS receiving at least in the area of the 3 stations receiving signal X. The best way to achieve an effective system and method that allows majority voting to effectively detect attempts to compromise, there needs to be a highly distributed network of receivers, and to alter the weighting of signals from receivers based on their distance from one another. Thus, a system and method of the present inventions configured in that matter allows for a confident determination that, for example, the signals at receivers R1 and R2 are compromised because many other receivers are consistently reporting signals different (outside of threshold) from those two receivers.

Because it is not known beforehand the scope of spoofing or jamming that may be affecting the area A1, the system and method of the present invention is prepared to assume that multiple receiving stations are being simultaneously affected. In order to discern true from false (or incomplete or non-existent) signals, the system and method of the present invention relies upon a number of geographically distributed receivers R1, R2, R3, R4, R5, R6, R7, R8 so that at least some of the receivers receive true signals from the satellites S1, S2, S3, S4.

As an example, if a single satellite signal is being spoofed by spoofer or jammer S/J, the processing hub P will receive signals from a number n of receivers R1, R2, R3, R4, R5, R6, R7, R8. At t0, all n receiving stations R1, R2, R3, R4, R5, R6, R7, R8 should report the same clock and ephemeris info for a particular satellite. If the processing hub P receives one signal from one or more of the receiving stations R1, R2, R3, R4, R5, R6, R7, R8 which is different from the others in clock or ephemeris, then there is a very high probability that that particular satellite's signal is being spoofed.

The system includes a mechanism to detect and exclude corrupt messages. The messages from the satellites S1, S2, S3, S4 include a cyclic redundancy check (CRC) which is intended to allow the receiver to detect and exclude messages that have been corrupted in transit—whether intentionally or not, corruption in transit is a fact of data communications. Occasionally a message will be corrupted but still pass a CRC check—this is a matter of statistical probability. The system will be configured to ignore N suspect messages from a particular station where the default for N is 1.

If the hub receives several signals from receiving stations R1, R2, R3, R4, R5, R6, R7, R8 which deviate from expected signals, then the signal which is consistent between the most receivers is deemed to be correct, (“Majority voting”). Clearly this scheme would have little validity if there were only a small number of receivers in proximity—it would be reasonable to anticipate a spoofing episode that affected, say, three out of four receivers For this reason it is important to have sufficiently large number of receivers distributed over a sufficiently large area that any single spoofer or jammer is unable to overwhelm or outnumber the ‘truth’.

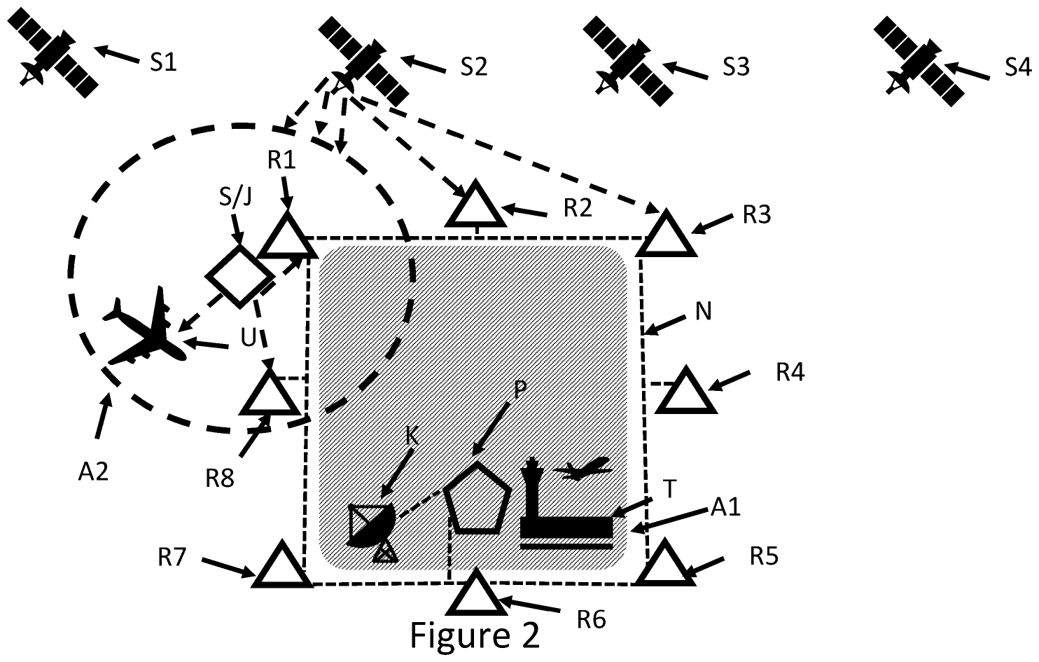

FIG. 2 shows the initial data flow of the implementation of the present invention shown in FIG. 1. Every GNSS satellite S1, S2, S3, S4 transmits an open signal including both ephemeris and clock data. These signals are intended to be received by a user U, but are also received by GNSS receiving stations R1, R2, R3, R4, R5, R6, R7, R8 positioned around area A1 of interest. The spoofer or jammer S/J transmits a fake, misleading or previously recorded signal, into or around the area A1 of interest. In the flow diagram of FIG. 2, the GNSS signal from satellite S2 is received without interference by two of the receiving stations R2 and R3, but the signal from satellite S2 to receiving stations R1 and R8 passes into the area A2 and is overcome by a more powerful spoofing signal, or may be interfered with by a jamming signal, emitted by a spoofer or jammer S/J. Thus, the signal from satellite S2 is not received by receiving stations R1 and R8, but instead the signal from the spoofer or jammer S/J is received by those receiving stations instead. As soon as user U enters into area A2, it too does not receive a signal from satellite S2, and it too—like receivers R1 and R8—instead receives a signal from spoofer or jammer S/J—at that time, neither the user U nor the GNSS receivers R1 and R8 can isolate and decode the signal from satellite S2 because that signal is overcome by the signal from the spoofer or jammer S/J.

The GNSS receivers R2 and R3 receiving accurate signals from GNSS satellite S2, as well as the GNSS receivers R1 and R8 receiving inaccurate or incomplete signals from the GNSS satellite S2 as a result of spoofer or jammer S/J both relay information about their received signals to central processing hub P. In one embodiment of the present invention, that information is transmitted over a hard-wired network so as to prevent efforts to spoof or jam the transmission from the receivers R1, R2; in another embodiment, this transmission is done wirelessly using encrypted or other secured wireless transmission technologies, so as to be secure against spoofing or jamming. The processing hub P compares the signals transmitted for each satellite S1, S2, S3, S4 as received by the different receivers R1, R2, R3, R4, R5, R6, R7, R8, with an allowance for the expected time delay between stations. That is, the system and method of the present invention ensures that it is comparing the signal emitted from the satellite at t0. Because the receiving stations R1, R2, R3, R4, R5, R6, R7, R8 are at different distances from any particular satellite S1, S2, S3, S4, and at are also at different distances from the processing hub P, speed-of-light time delay must be corrected for both for signals from a particular satellite S1, S2, S3, S4 to a particular receiving station R1, R2, R3, R4, R5, R6, R7, R8 as well as from a particular receiving station R1, R2, R3, R4, R5, R6, R7, R8 to processing hub P . Fortunately, the message frames include the information to permit this correction.

GPS L1 C/A signals are organized into 1500-bit frames divided into 300-bit subframes transmitted at 50 bps. Each subframe contains clock information. Every 6 seconds a new subframe is sent.

The processing hub receives these subframes within milliseconds to tenths of a second, depending on the distance between the hub and the number of internet processing hops. Once the processing hub has correlated the subframes that have been received by the receivers, it can readily determine if they are identical, as they should be. If the subframes are not all identical then the processing hub identifies which receivers have sent the different ones. Because there is enough information and little enough latency, the processing hub can detect which receivers are receiving subframes that have been tampered with or are inaccurate or insufficiently strong. The processing hub can also anticipate the difference between subsequent subframes of a particular type, and if the difference is greater or lesser than anticipated, raise an alarm. This works because the ephemeris changes very slowly and infrequently, compared to the frequency with which the messages are sent. For instance, the clock time should be advancing very similarly for the satellites and the onboard clock of the receiver, even if the receiver's clock has less precision. A change in satellite clock greater than the change in the receiver's clock is a potential problem. Also, the satellite's orbit parameters can be persistent over hours, and can't suddenly change because the satellite is just obeying the laws of physics in a near-vacuum. Hence a receiver that has prior data (as opposed to one that just got turned on, a.k.a. “cold start”) has potential clues to spoofing.

The receiver attaches fairly accurate timestamps to packets sent to the processing hub. The timestamp accuracy can be maintained by a combination of the GNSS receiver (which itself is susceptible to spoofing) and terrestrial-based Network Time Protocol (NTP). The processing hub can use these timestamps to supplement its interference detection algorithms.

When the processing hub P detects a spoofing or jamming event, it sends an alert to interested parties such as the target T. The target T may validate that the alert indicates an effort to misdirect the user U away from the area A1 at the target T, and relay that alert to the user U so that they know not to rely on the location information calculated by the GNSS signal receiver located on board user U.

In one embodiment of the present invention, the processing hub P of the present invention can be used to calculate the area (or volume) A2, and alert the U of the location and size of that area A2, so that the user U can direct itself away from that are to ensure the integrity of the navigation signals it is receiving and using. In another embodiment of the present invention, the processing hub P may be used to relay to the user U correct location information signals—preferably using a secure and possibly encrypted signal—to the user U so that it may use those signals instead of potentially spoofed or jammed signals it may be receiving when navigating in, or near, the area A2 in which spoofing or jamming may be occuring.

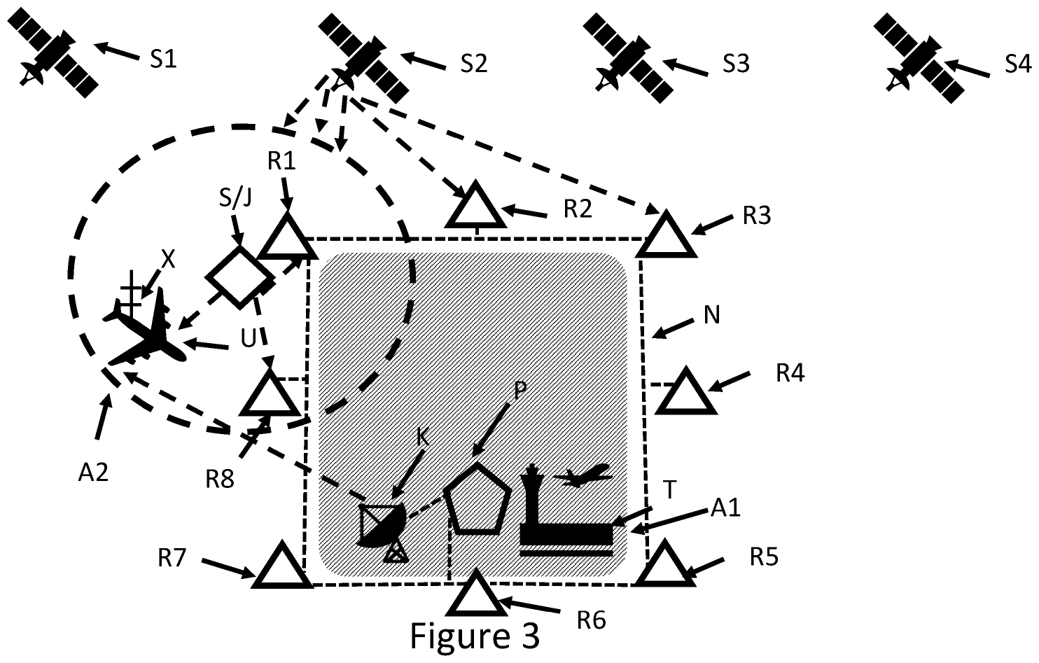

FIG. 3 is a more detailed view of the information flow of an embodiment of the present invention. Satellite S1 broadcasts a signal which contains information about that satellite's precise orbital position, which will support the position calculation ; as well as its clock, representing the time at which the signal has been sent. Satellites S2, S3 and S4 likewise broadcast a signal transmitting information about their precise orbital position and clock.

All of the signals from the satellites S1, S2, S3, S4 travel at the speed of light in vacuum. The signal is slowed down somewhat by the ionosphere and troposphere, as the result of traveling through non-vacuum media, and compensating calculations need to be made (as defined in the GPS Interface Control Documents (ICD)), but for the purpose of describing the present invention adjustment for speed variations as the result of transmission through media will not be detailed, and the description below is based on the signals from the satellites S1, S2, S3, S4 are assumed to travel to the receivers R1, R2, R3, R4, R5, R6, R7, R8 entirely through a vacuum.

Each satellite S1, S2, S3, S4 broadcasts its clock and orbital position data at a time t0. Each receiver R1, R2, R3, R4, R5, R6, R7, R8 compares its own internal clock with the clock information transmitted by any satellite S1, S2, S3, S4 that transmits a signal that that receiver R1, R2, R3, R4, R5, R6, R7, R8 receives. The difference between the internal receiver clock and the satellite clock is designated as Δt. Dividing the speed of light in a vacuum—approximately 3*10⁸ m/s—by the calculated Δt yields the distance between any one particular satellite S1, S2, S3, S4 and the receiver R1, R2, R3, R4, R5, R6, R7, R8 which receives that signal at the time t0 at which that signal was transmitted. Thus, each receiver R1, R2, R3, R4, R5, R6, R7, R8 can compute the location in space of each satellite S1, S2, S3, S4 at time t0.

Any particular receiver R1, R2, R3, R4 receives information about its own location according to the formula:

Satellite Sn: Xₙ, Yₙ, Zₙ

Where n is the number of a particular satellite. A well-known and relatively simple, known algebraic equation can be used for a particular receiver R1, R2, R3, R4, R5, R6, R7, R8 to calculate its own X, Y and Z position from the received satellite position and clock information.

All locations of receivers R1, R2, R3, R4, R5, R6, R7, R8 are calculated by processing hub P using an earth-centred-earth-fixed reference model and corrections are then applied to allow for the rotation of the earth. Details of how this reference models compensate for earth rotation, impedance of signals from the speed of light in a vacuum due to media delays, and other corrections to location and time date from satellite signals are published in the GNSS system's interface control document (ICD). There are known techniques to manage inconsistent and redundant signals from multiple satellites, such as Kalman filters. For instance, a Kalman filter maintains information about the state of the system and the variance of its parameters, and as information is added, it applies a weighted average based on the certainty of the new parameters, in a recursive manner.

A spoofer may use a signal that has been recorded from a particular location at a previous time, and alter it to suit the spoofed location it is attempting to represent via the spoofing signal, or it may use the actual incoming current signal from a satellite S1, S2, S3, S4 and modify the transmitted information slightly, and then rebroadcast it. The present invention is designed to ensure that in either case, or in the case of merely overpowering an incoming satellite signal via jamming, accurate location information is calculated and transmitted to the user U so as to prevent mis-navigation. Signals—either an alert, or corrected or relayed true positional signals from receivers which are not subject to spoofing or jamming—may be transmitted to user U using a transmitting antenna K. The present invention could also be configured to calculate the area (or in the case of vehicles moving in three dimensions, such as aircraft, volume) of an area that has been calculated—based on detection of false signals received from receivers in that area/volume—to be subject to spoofing or jamming, and alert a user U of the location of those areas so the user U could decide to redirect the vehicle away from that area. The user U includes one or more antennae X which may be used separately, or as a single antenna, to receive GNSS signals from satellites S1, S2, S3, S4 and from transmitting antenna K.

As a result of the system and method of the present invention being able to both know the correct positional location of each of the receivers R1, R2, R3, R4, R5, R6, R7, R8 as well as to determine when any particular receiver R1, R2, R3, R4, R5, R6, R7, R8 is within the area A2 where spoofing or jamming is occurring because the location information from that receiver is transmitted to the processing hub P location information that deviates from its fixed, known, location data, the system and process of the present invention is able to detect the deviation and remove that receiver from location calculations at the user U. The processing hub P correlates the data from multiple receivers R1, R2, R3, R4, R5, R6, R7, R8 and uses deviation information between location calculated by received information and location information known about each receiver's fixed location based on unjammed or unspoofed data, thereby allowing the processing hub to calculate the area A2 affected by the spoofer or jammer, and discard and data received from any receiver R1, R2, R3, R4, R5, R6, R7, R8 that is transmitting information to the processing hub P. The processing hub maintains a database of the true locations of all the receivers, based upon calculations or other measurements of the location of those receivers known to be true and not subject to any interference. This database may be used to compare signals from the receivers at any time, and to therefore detect when those signals are false because of spoofing or jamming, when they fall outside of set variance thresholds for those locations.

When the hub detects that multiple receivers in a region are receiving interference through spoofed or jammed signals, it can make a coarse deduction of the area affected by interference based on the locations of the affected receivers and interpolate that the area between and around them is also affected. The accuracy of this deduction is increased as the number of receivers in this system increases.

Any information useful for user U to alert it to an area A2 to avoid, or to provide secure alerts, to relay or otherwise transmit correct location information, can be done using an antenna K in signal connection with processing hub P and designed to transmit signals receivable and translatable by user U.

In the present invention, because the actual location of the receivers R1, R2, R3, R4, R5, R6, R7, R8 is known or calculable at a time when there are no spoofing or jamming signals nearby, and because the system and method of the present invention maintains an independent time standard, when any receiver calculates a wrong position for itself based on data from the spoofer or jammer S/J, or cannot calculate a location for itself as the result of jamming, the system and method of the present invention is able to detect the deviation between the false and true location of that receiver. The processing hub correlates the data from multiple receivers to approximate the area A2 affected by the spoofer or jammer S/J.

Any of the receivers R1, R2, R3, R4, R5, R6, R7, R8 in the system and method of the present invention which are out of range of the spoofer/jammer S/J will continue receiving the correct satellite signals and thereby are able to maintain an accurate time standard for the overall system, and also act as a flag when incorrect time information is transmitted by a compromised receiver.

The receiving stations receiver R1, R2, R3, R4, R5, R6, R7, R8 can be used to detect a jammer because it is unable to extract the signal from any one of the satellites S1, S2, S3, S4 from the noise generated by the jammer. By using the system and method of the present invention, a user U can be reassured that some or all of the GNSS signals it is supposed to receive are not being interfered with, and that that condition is not equipment malfunction.

In addition to the above method, the central processing hub may also to detect spoofing in the following way. Each receiver R1, R2, R3, R4, R5, R6, R7, R8 receives the ephemeris from overhead satellites S1, S2, S3, S4 (or spoofer S/J). Each receiver R1, R2, R3, R4, R5, R6, R7, R8 relays the ephemeris it receives (whether true, or false) to the central processing hub P. The central processing hub P is able to compare the received ephemeris from multiple receivers R1, R2, R3, R4, R5, R6, R7, R8 and detect falsified data by comparing timing, location, or other data deviations from expected values. This is because each satellite S1, S2, S3, S4 is broadcasting its own ephemeris, so all receivers R1, R2, R3, R4, R5, R6, R7, R8 should receive the same messages from the same satellite. The hub can use a majority-voting scheme to determine which signal is correct, and to discard those signals that are incorrect based on deviation analysis. Users near the receivers R1, R2, R3, R4, R5, R6, R7, R8 receiving the incorrect messages can receive a warning alert, or the central processing hub P can send out corrected location information to the user after discarding of signals known to be false. Similarly, when multiple receivers R1, R2, R3, R4, R5, R6, R7, R8 are detected to be not receiving signals because of jamming, the central processing hub P is able to infer which users U within the jammed area A2 need to receive a warning alert, or have corrected location information transmitted to them.

Interested parties may subscribe to the system and method of the present invention to receive alerts about identified spoofing or jamming activity. This can be broken down into three service levels:
Basic. A user subscribes to the service and receives alerts via an encoded radio message and/or via the internet. For instance, the system may send a text message, or send a message to a suitable software system ‘app’ on a mobile phone. This service level would typically be offered for consumer devices for which location accuracy may not be of criticality for safety or other reasons.
Professional. A specially constructed receiver on board with the user U consisting of hardware and software, suitable for mounting on a ship's bridge, aviation cockpit, or other location accessible to a navigator, pilot, or captain receives the alert via radio or cellular signal or even a dedicated secure wireless transmission system.
Partner. A company that presently supplies navigation equipment to, e.g., a maritime fleet incorporates this system—including an on-board secure receiver for alerts or corrected location information—into their products. This has the advantage that many of the homologation and integration issues are already managed and no additional hardware is required on the bridge.

When multiple receivers in a region are subject to the same interference, the present invention can interpolate that all points between and near to these receivers are also subject to this interference. As a useful approximation, the system and method of the present invention assumes that the interferer is located at the centroid of the locations of all receivers that are subject to interference, with a radius large enough to include all subject receivers. In the present invention, if there are receivers within the calculated region that are not subject to interference, then the area around such a receiver is treated independently from the calculated area of interference. If the receivers are within, for example, tens of kilometres of one another, the system and method of the present invention assumes the zone of interference extends halfway between those two receivers. This calculation is not a completely accurate calculation of an area of interference, but it does serve as a useful approximation of affected areas.

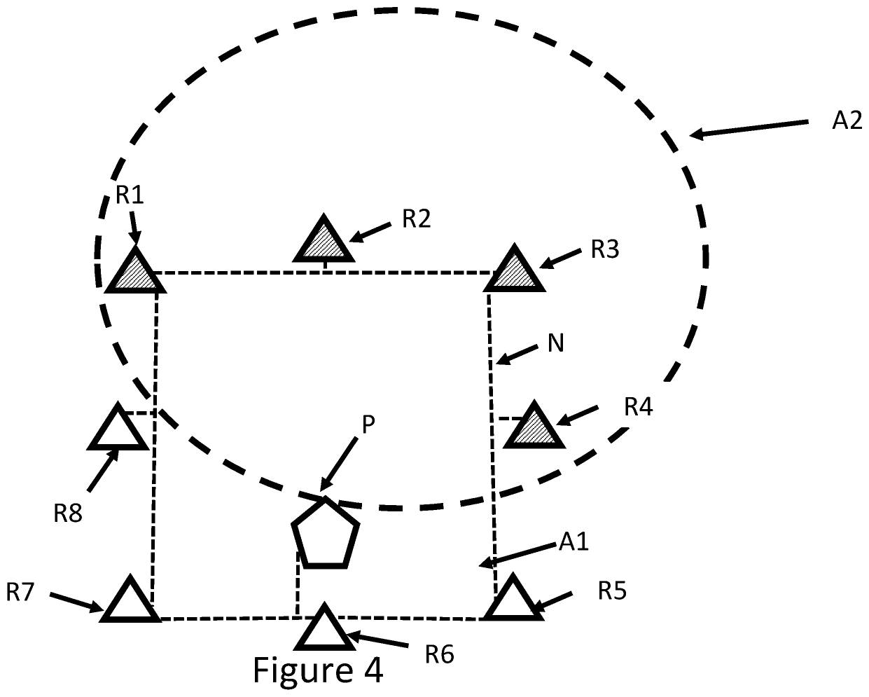

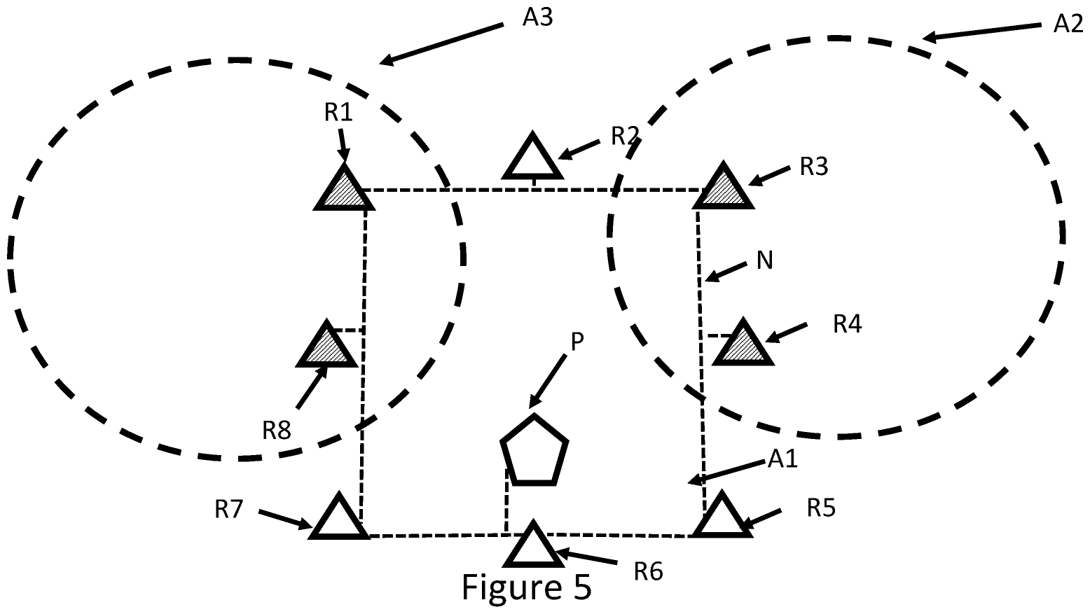

FIGS. 4-5 show the manner in which an area, or areas, of interference may be approximated based upon detection of receivers that may be transmitting correct and incorrect location information. In FIG. 4, receivers R1-R4 are shaded, indicating that those receivers are determined by the processing hub P to be receiving false location information as the result of spoofing or jamming, using the system and method of the present invention. The processing hub P is able to determine an approximate area A2 of interference by interpolating an area which encompasses the receivers R1-R4 but which does not include the receivers R5-R8 which are determined to be receiving true location signals (and are hence unshaded in FIG. 4), with the edge of the area A2 being interpolated as halfway between receivers R1 and R4 receiving false signals and receivers R8 and R5 receiving true signals. In FIG. 5, receivers R1, R3, R4, and R8 are shaded, indicating that those receivers are determined by the processing hub P to be receiving false location information as the result of spoofing or jamming. The processing hub is able to determine two approximate area A2 and A3 of interference by interpolating areas which encompasses the receivers R1, R3, R4, and R8 but which does not include the receivers R2, R5, R6, and R7 which are determined to be receiving true location signals (and are hence unshaded in FIG. 5), with the edge of the areas A2 and A3 being interpolated as halfway between receivers receiving false signals and receivers receiving true signals.

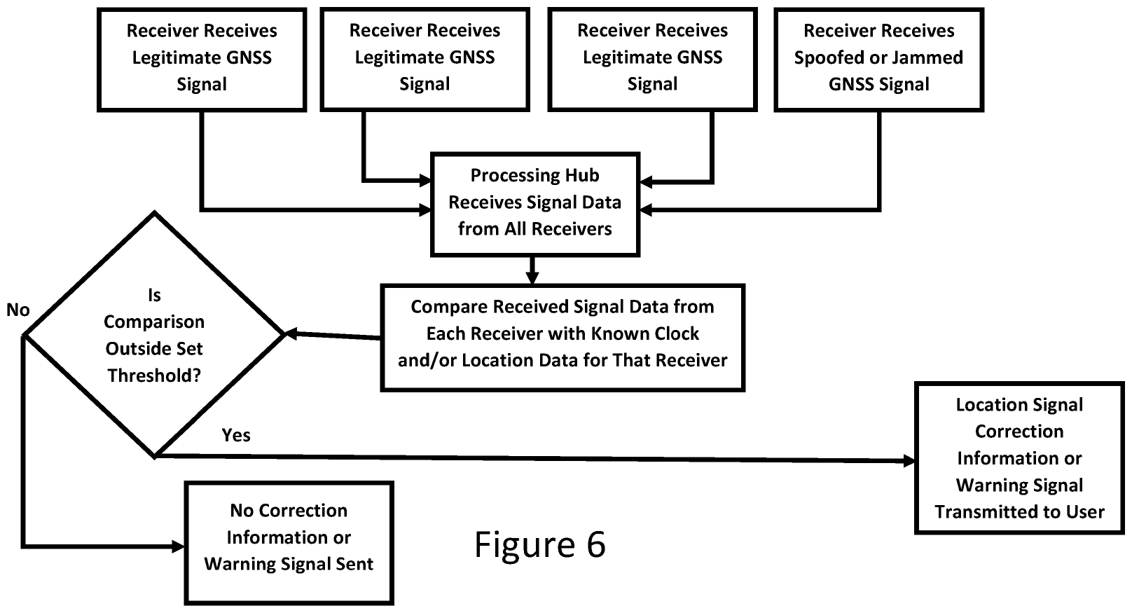

FIG. 6 is a flow chart of one embodiment of the present invention. Signals are received by receivers R1, R2, R3, R4, R5, R6, R7, R8, some of which are true signals from satellites S1, S2, S3, S4 and some of which are false from spoofer or jammer S/J. All of these signals are relayed to processing hub P. Processing hub P then takes the signals received and does comparison analysis of those received signals against known true information to determine which receivers R1, R2, R3, R4, R5, R6, R7, R8, are receiving known good signals and which receivers R1, R2, R3, R4, R5, R6, R7, R8, are receiving false signals.

All of the signal information from receivers R1, R2, R3, R4, R5, R6, R7, R8 are sent to processing hub P. The processing hub P includes electronic storage (such as a hard drive) in which a database is stored. The database may contain previously stored, or otherwise calculated, known and accurate location and clock data for each of the receivers R1, R2, R3, R4, R5, R6, R7, R8. The processing hub compares the signal received from each receiver to the stored or calculated known, accurate, location and clock data for that receiver, and determines if there is a discrepancy sufficient to trigger an alert. A discrepancy may be determined based on set, and stored, threshold values set either for all receivers, or individually for each receiver, if there are known differences in variability tolerance for different receivers. If the comparison between location signals received from a receiver and the known, accurate, stored data for that receiver indicates that that signal is outside of the threshold for that receiver, some form of alert may be transmitter to the user U. The alert may be in the form of a simple warning signal, or—as described in more detail below—more informative warning information as the location and size of an area calculated to be subject to jamming or spoofing.

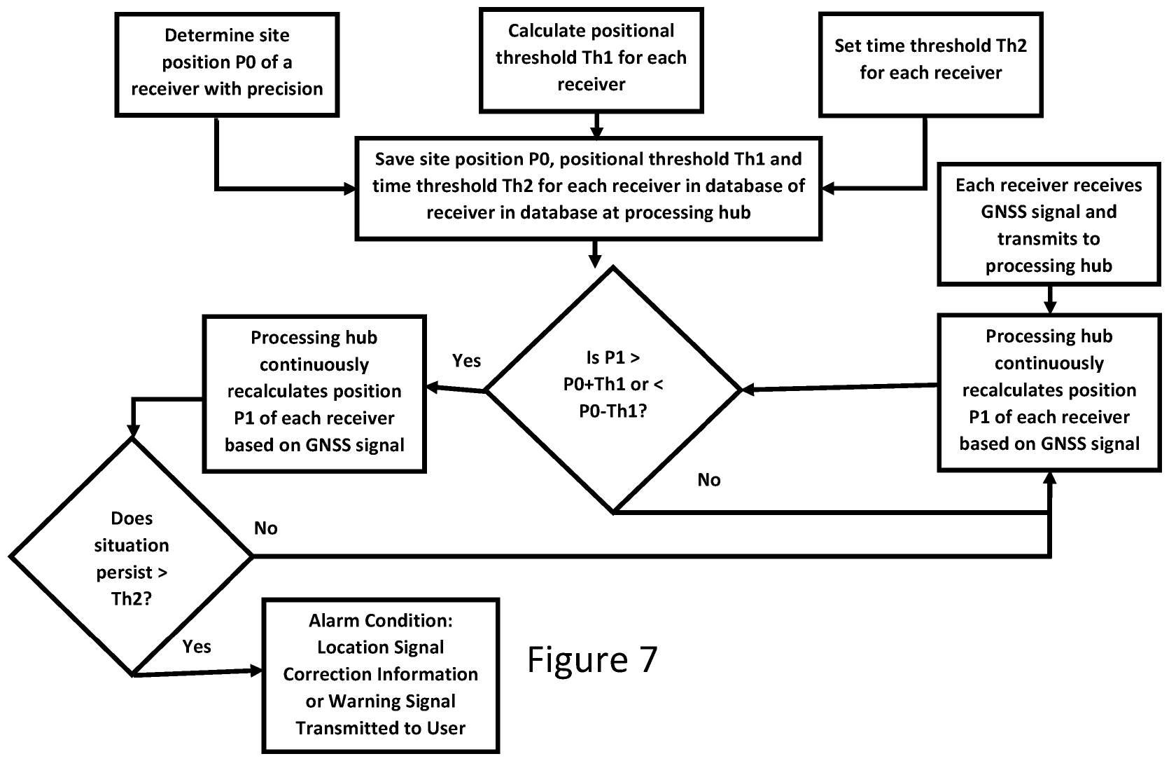

FIG. 7 is a flowchart showing one method for determining, with appropriate accuracy and to eliminate false warnings, if there is spoofing or jamming in an area of coverage using the system of the present invention. Each of the receivers R1, R2, R3, R4, R5, R6, R7, R8 is stationed at a position, which position P0, has been calculated with accuracy under conditions where that calculation is not subject to any interference or variance. For each of the receivers R1, R2, R3, R4, R5, R6, R7, R8 a positional threshold Th1 is determined, the positional threshold being set at a value which accounts for natural variations in positional information calculated for any particular receiver as the result of atmospheric conditions, distances from the processing hub P, etc. Also, for each of the receivers R1, R2, R3, R4, R5, R6, R7, R8 a time-based threshold Th2 is determined; the time-based threshold Th2 is set at a value so that ephemeral variations outside the threshold Th1 do not trigger a warning, but instead only variations in positional data are sustained over a sufficiently lengthy period of time to indicate an intentional act to alter positional data sent from a receiver to the processing hub P. All of these values, P0, Th1 and Th2 for each receiver are stored in a database accessible by the processing hub P. During operation of the system of the present invention, real-time position information for each receiver is received from the GNSS system (for true signals) or from a spoofer or jammer S/J (for false signals) and transmitted to the processing hub P. The processing hub P takes that positional information and calculates a real-time position P1 for each receiver. The processing hub P then unloads P0, Th1 and Th2 information for each receiver, and adds the P0 value to Th1 value for a receiver to calculate a range of positional calculations considered by the system of the present invention to be “true.” The calculated real-time position P1 is then compared to this threshold range; if it falls within this range, the calculated position P1 is considered to be accurate; if it falls outside of this range (either more than the high end of the range, or less than the low end), then the position P1 is considered to be potentially false. These calculations are repeated over a time period, and if the position P1 is considered to be false continuously over a time period greater than the time threshold T2, then a spoofing or jamming event is considered to be occurring at the receiver for which false positions P1 persist over the time threshold T2. A warning of some sort is then sent to user U.

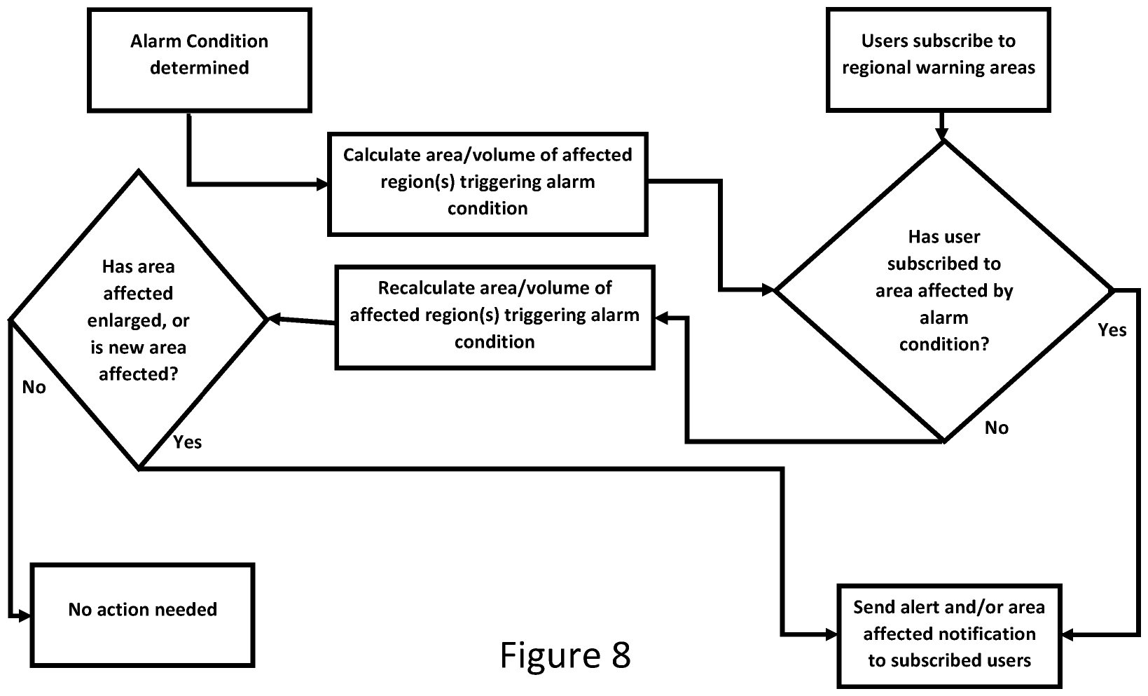

It should be noted that the features of the various methods described above and show in FIGS. 6-8 could be combined in various combinations to allow for different types or levels of alerts sent to user U or to provide different levels of assurance of integrity of the GNSS signals that may be received by the user U or to determine the areas A2, A3 which are affected by attempt to disrupt navigation. The present inventions contemplates using various of the described techniques in various combinations to achieve optimal results.

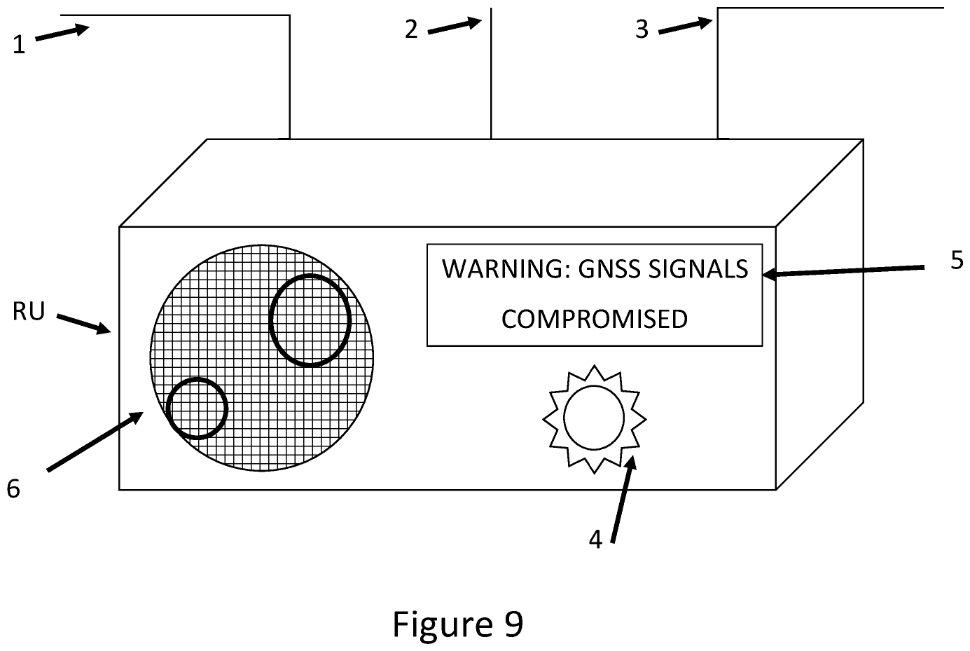

FIG. 9 is a representation of a receiver unit RU that may be used by the user U of the present invention. The receiver unit RU could be a dedicated device installed in the vessel of the user U specifically for the system and method of the present invention, or could be an existing navigational system which is adapted, using dedicated software and possibly a dedicated antenna, to implement the system and method of the present invention within that navigational system. The receiver unit RU would typically include at least three cables—power 1, local electronics bus 2, and antenna bus 3. Power cable 1 would be connected to the on-board power system to provide power to the receiver unit RU. Local electronics bus 2 would connect the receiver unit RU to existing electronics systems (for example, in an aircraft, to the on-board avionics system) on the vessel. Antenna bus 3 would connect to an antenna used to receive signals from transmitting antenna K so as to supply alerts to the user U. The alerts can take one or, or combinations of, many different forms, including a flashing light 4 (alone, or accompanied by an audio signal), a textual warning 5, or in more advanced systems, a navigational map 6 upon which the location and calculated areas of affected areas A2, A3 are displayed.

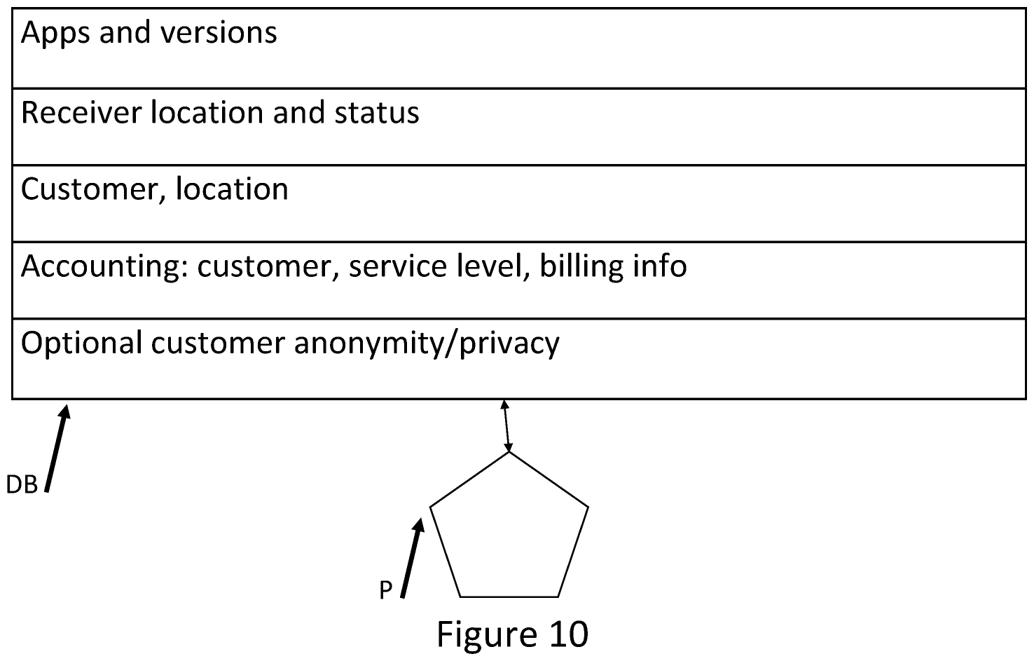

FIG. 10 is a representation of an embodiment of the present invention that uses a stored database DB which may be accessed by the processing hub P in order to more discretely process information from the system and method of the present invention to better serve different users U based on their customer level as well as to better interpret and analyze information from the system itself. The database DB may contain information such as:
The applications or other software which may be running on the receiver unit RU of particular users U, so that alerts may be tailored for that particular receiver unit. For example, a receiver unit RU that has a navigational map 6 will be sent different information (for example, the location and size of affected areas A2, A3) than a receiver unit RU that only contains a flashing light 4.
Receiver R1, R2, R3, R4, R5, R6, R7, R8 location and status information, including stored position P0 as well as thresholds Th1 and Th2 for each receiver. Status information about receivers (such that any particular receiver is off-line or potentially compromised) may also be stored in the database DB.
Information about customers for the system and method of the present invention, including their level of subscription, when the subscription expires, and unique, identifiable information about the receiver unit RU falling within their subscription.
Accounting information for each customer to keep track of the status of their account and how that account is billed to the customer.
Optional anonymity information regarding at least some of the customers, to prevent potential data breaches of customer's confidential information.

All of the information in the database DB may be used by the system and method of the present invention to provide appropriate levels of service to users U according to their needs, their financial subscription level, and the equipment that may be resident on the vessel accessing the present invention.

Each satellite broadcasts the same information to all users, in a given signal. The messages in the signal repeat every 22.5 minutes, so it is a straightforward exercise to compare the message (subframe) transmitted at to, even though it is received at slightly different times due to the varied distance from each satellite to the receivers, and from the receivers to the processing hub. A simple binary comparison of each 300-bit subframe is sufficient to detect which receivers are receiving an altered message.

The correct information may then be transmitted to the user U so that the user U can take mitigation steps to prevent mis-navigation.

A user U device may use multiple constellations to calculate its position; it just needs to know the inter-constellation time offsets as well as the different reference systems.

The user U device typically has a relatively cheap and simple clock on board. Only larger and more expensive reference receivers may connect to an atomic clock which is of comparable quality to the GNSS satellite's on-board atomic clock. Therefore, it is customary for the navigation system used by the user U to use its own clock only for the very coarse portion of signal acquisition, and then trusts the atomic clocks of the four or more satellites it is receiving in order to do GNSS location identification. The navigation system used by user U may even reset its own internal clock to match the received time from the more accurate clocks on the satellites S1, S2, S3, S4. If a spoofer S/J is broadcasting a wrong clock signal this can affect the end user's system and possibly cause that system to reset its own clock to an inaccurate time. For instance, some software systems require a check against GNSS time to determine whether the license to that software is valid and the user U may intentionally spoof the clock to keep the software running when the license has actually expired. The present invention could be used by the vendor of that software to ensure the user U is not self-spoofing its own system in order to circumvent restrictions on the time period for using that software, by detecting self-spoofing by a user and disabling the software that relies upon a GNSS clock in order to keep the software license valid.

The description and drawings describe but a few of the potential embodiments of the present invention. Although the embodiment described above uses an airport as the area of interest and an aircraft as the user of the system, the invention is equally adaptable and applicable to maritime or general transportation uses, such as harbours, shipping channels or straits, high-traffic or dangerous roadways or rivers, as well as a system to improve the integrity of autonomous driving, flying, or sailing when GNSS location systems are an important part of a driverless, pilotless or navigator-less system.

Interested parties may subscribe to this system and receive alerts and updated and accurate location information in a secure manner. For instance, an airport authority may receive the alerts at the Air Traffic Control Centre (ATCC) and controllers can relay the information to nearby aircraft so that they can adjust their navigation system so as to discount location signals identified as false or jammed. Likewise, a shipping company could equip its vessels with alert receivers and internal systems to account for false or jammed signals. Alerts may be sent to subscribers via encoded radio message and/or via the internet, as long as these messages are made in a secure fashion so that they are also not subject to spoofing or jamming. The system should be designed to ensure that only messages relevant to a user are displayed. For instance if there is a spoofing incident in one location—for example, Boston, Massachusetts, USA—a subscriber in Seattle, Washington, USA wouldn't need to receive an alert, but a subscriber in Providence, Rhode Island, USA, might wish to receive an alert as the spoofing or jamming might equally effect some signals relied upon at that location.

1. A system for ensuring accurate location information in a device designed to receive satellite location signals, comprising:
a plurality of earth-based receivers having previously-determined known locations, wherein the plurality of earth-based receivers are designed to receive location calculation signals from a constellation of satellites;
a processing hub in signal connection with each of the plurality of earth-based receivers, wherein the processing hub receives relayed location calculation signals from the plurality of earth-based receivers and wherein each of the relayed location calculation signals are compared against known good signal data to identify signals that may not be accurate.

2. The system of claim 1, wherein:
the comparison against known good signals is conducted relative to thresholds within which the relayed location calculation signals may fall without being considered not accurate.

3. The system of claim 2, wherein:
the comparison against known good signals is conducted using known good clock information relative to clock information in the relayed location calculation signals.

4. The system of claim 2, wherein:
the comparison against known good signals is conducted using known good location information relative to location information in the relayed location calculation signals.

5. The system of claim 1, wherein:
the processing hub performs a calculation to determine any area where relayed location calculation signals are not accurate.

6. The system of claim 1, wherein:
the processing hub sends an alert signal to a receiving unit to alert a user to the presence of inaccurate location calculation signals.

7. The system of claim 6, wherein:
the alert signal includes information regarding the location and area where relayed location calculation signals are not accurate.

8. A method for ensuring accurate location information in a device designed to receive satellite location signals, comprising the steps of:
providing a plurality of earth-based receivers;
receiving location calculation signals at the plurality of earth-based receivers from a constellation of satellites;
providing a processing hub in signal connection with each of the plurality of earth-based receivers;
relaying location calculation signals from each of the plurality of earth-based receivers to the processing hub;
comparing each of the location calculation signals against known good signal data to identify signals that may not be accurate.

9. The method of claim 8, wherein:
the step of comparing against known good signal data comprises comparing relative to thresholds within which the relayed location calculation signals may fall without being considered not accurate.

10. The method of claim 9, wherein:
the step of comparing against known good signal data uses known good clock information relative to clock information in the relayed location calculation signals.

11. The method of claim 9, wherein:
the step of comparing against known good signal data uses known good location information relative to location information in the relayed location calculation signals.

12. The method of claim 8, further comprising the step of:
performing a calculation to determine any area where relayed location calculation signals are not accurate.

13. The method of claim 8, further comprising the step of:
sending an alert signal to a receiving unit to alert a user to the presence of inaccurate location calculation signals.

14. The method of claim 13, further comprising the step of:
including in the alert signal information regarding the location and area where relayed location calculation signals are not accurate.

15. A navigational system in a vessel for ensuring accurate navigation when using satellite location signals, comprising:
a location system antenna for receiving location calculation signals from a constellation of satellites;
a receiving unit for calculating location based on the signals from the constellation of satellites, the receiving unit including an alert system antenna;
the receiving unit including an alert system to receive alerts from the alert system antenna and transmit an alert signal to a vessel operator when the integrity of the signals received by the location system antenna are determined to be inaccurate.

16. The receiving unit of claim 15, wherein:
the alert signal includes information regarding the location and area where location signals are not accurate.
